(19) United States
(12) Patent Application Publication
(10) Pub. No.: US 2025/0202545 A1
(43) Pub. Date: Jun. 19, 2025

(54) METHODS AND APPARATUS OF CSI REPORTING FOR COHERENT JOINT TRANSMISSION

(71) Applicant: LENOVO (BEIJING) LIMITED, Beijing (CN)

(72) Inventors: Yi ZHANG, Beijing (CN); Chenxi ZHU, Fairfax, VA (US); Wei LING, Beijing (CN); Bingchao LIU, Beijing (CN); Lingling XIAO, Beijing (CN)

(21) Appl. No.: 18/844,618

(22) PCT Filed: Apr. 29, 2022
(86) PCT No.: PCT/CN2022/090296

§ 371 Date: Sep. 6, 2024

(51) Int. Cl. H04B 7/0417; H04B 7/0452; H04B 7/06

(52) U.S. Cl. CPC H04B 7/0417; H04B 7/0452; H04B 7/0626; H04B 7/0632

(57) ABSTRACT

Methods and apparatus of CSI reporting for coherent joint transmission are disclosed. The apparatus includes: a receiver that receives a configuration signalling for Channel State Information (CSI) reporting for a first transmitting-receiving entity and a second transmitting-receiving entity, wherein the CSI reporting comprises a joint CSI reporting or a plurality of linked CSI reportings; a processor that determines contents of the CSI reporting based on the configuration signalling, wherein the joint CSI reporting or each one of the linked CSI reportings comprises a first part and a second part; and a transmitter that transmits the CSI reporting.

### FIELD

The subject matter disclosed herein relates generally to wireless communication and more particularly relates to, but not limited to, methods and apparatus of CSI reporting for coherent joint transmission.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Physical Broadcast Channel (PBCH), Bandwidth Part (BWP), Channel State Information (CSI), Channel State Information Reference Signal (CSI-RS), Downlink Control Information (DCI), Frequency Division Duplex (FDD), Frequency Division Multiple Access (FDMA), Index/Identifier (ID), Modulation Coding Scheme (MCS), Multiple Input Multiple Output (MIMO), Physical Resource Block (PRB), Reference Signal (RS), Reference Signal Received Power (RSRP), Single Frequency Network (SFN), Signal-to-Interference-Plus-Noise Ratio (SINR), Synchronization Signal Block (SSB), Time-Division Duplexing (TDD), Transmission and Reception Point (TRP), Channel Quality Indicator (CQI), CSI Interference Measurement (CSI-IM), Frequency Range 1 (FR1), Frequency Range 2 (FR2), Layer 1 Reference Signal Received Power (L1-RSRP), Non-Zero-Power CSI-RS (NZP-CSI-RS), Precoder Matrix Indicator (PMI), Rank Indicator (RI), Synchronization Signal (SS), Technical Specification (TS), Layer 1/physical layer (L1), CSI-RS Resource Indicator (CRI), Layer Indicator (LI), SS/PBCH Block Resource indicator (SSBRI), Layer 1 Signal-to-Interference-Plus-Noise Ratio (L1-SINR), Synchronization Signals and Physical Broadcast Channel (SS/PBCH), Joint Transmission (JT), Non-Coherent Joint Transmission (NC-JT), Coherent Joint Transmission (CJT).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHZ range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

It is important to identify and specify necessary enhancements for both downlink and uplink MIMO for facilitating the use of large antenna array, not only for FR1 but also for FR2, to fulfil the request for evolution of NR deployments in Release 18.

In 3GPP specification Release 16 and Release 17, features for facilitating multi-TRP deployments have been introduced, focusing on non-coherent joint transmission (NC-JT).

As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments.

### SUMMARY

Methods and apparatus of CSI reporting for coherent joint transmission are disclosed.

According to a first aspect, there is provided an apparatus, including: a receiver that receives a configuration signalling for Channel State Information (CSI) reporting for a first transmitting-receiving entity and a second transmitting-receiving entity, wherein the CSI reporting comprises a joint CSI reporting or a plurality of linked CSI reportings; a processor that determines contents of the CSI reporting based on the configuration signalling, wherein the joint CSI reporting or each one of the linked CSI reportings comprises a first part and a second part; and a transmitter that transmits the CSI reporting.

According to a second aspect, there is provided an apparatus, including: a transmitter that transmits a configuration signalling for Channel State Information (CSI) reporting for a first transmitting-receiving entity and a second transmitting-receiving entity, wherein the CSI reporting comprises a joint CSI reporting or a plurality of linked CSI reportings, and the joint CSI reporting or each one of the linked CSI reportings comprises a first part and a second part; and a receiver that receives the CSI reporting.

According to a third aspect, there is provided a method, including: receiving, by a receiver, a configuration signalling for Channel State Information (CSI) reporting for a first transmitting-receiving entity and a second transmitting-receiving entity, wherein the CSI reporting comprises a joint CSI reporting or a plurality of linked CSI reportings; determining, by a processor, contents of the CSI reporting based on the configuration signalling, wherein the joint CSI reporting or each one of the linked CSI reportings comprises a first part and a second part; and transmitting, by a transmitter, the CSI reporting.

According to a fourth aspect, there is provided a method, including: transmitting, by a transmitter, a configuration signalling for Channel State Information (CSI) reporting for a first transmitting-receiving entity and a second transmitting-receiving entity, wherein the CSI reporting comprises a joint CSI reporting or a plurality of linked CSI reportings, and the joint CSI reporting or each one of the linked CSI reportings comprises a first part and a second part; and receiving, by a receiver, the CSI reporting.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of coherent joint transmission with multiple TRPs in accordance with some implementations of the present disclosure.

FIG. 5 is a flow chart illustrating steps of CSI reporting for coherent joint transmission by UE in accordance with some implementations of the present disclosure; and

FIG. 6 is a flow chart illustrating steps of CSI reporting for coherent joint transmission by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

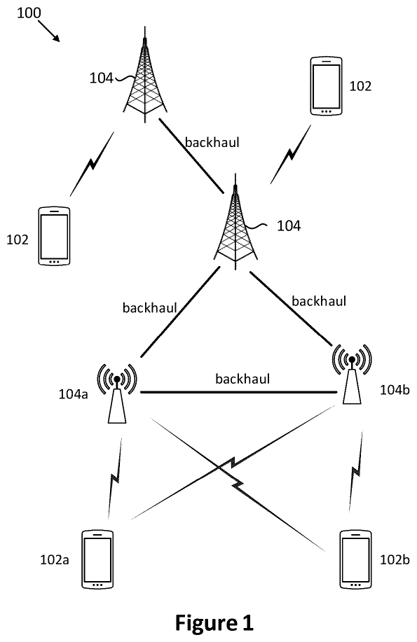

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

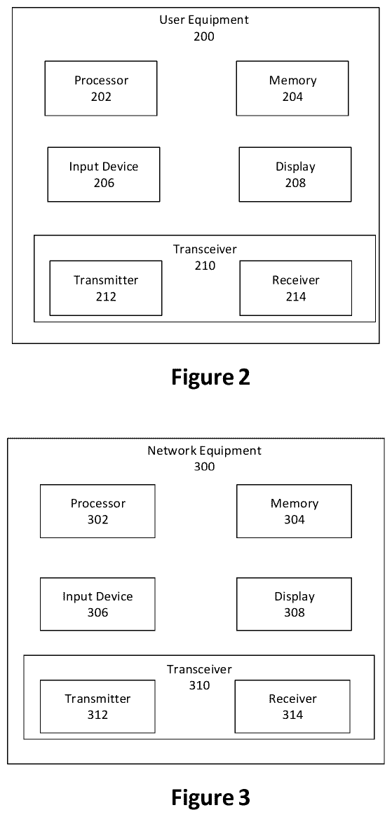

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

In Release 18, coherent joint transmission will be further studied, where the same information may be transmitted coherently from multiple TRPs. In the present disclosure, enhanced CSI reporting schemes are designed with consideration of CSIs from multiple TRPs for one coherent joint transmission with one joint or multiple linked or paired CSI reportings, PMI feedback based on enhanced Release 16 or Release 17 Type 2 codebook including additional CSI information between TRPs, and good compatibility between coherent joint transmission and single TRP transmission.

A CSI framework was designed in Release 15 based on single TRP based transmission. The related CSI framework and report settings/configurations are described as follows, extracted from section 5.2.1 of TS 38.214.

### Channel State Information Framework

The procedures on aperiodic CSI reporting described in this clause assume that the CSI reporting is triggered by DCI format 0_1, but they equally apply to CSI reporting triggered by DCI format 0_2, by applying the higher layer parameter reportTriggerSizeDCI-0-2 instead of reportTriggerSize.

The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP or L1-SINR.

For CQI, PMI, CRI, SSBRI, LI, RI, L1-RSRP, L1-SINR a UE is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig.

### Report Setting and Report Configurations

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator).

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related or L1-SINR-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II, Enhanced Type II CSI, or Further Enhanced Type II Port Selection including codebook subset restriction when applicable, and configurations of group-based reporting.

The UE shall calculate CSI parameters (if reported) assuming the following dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.

The Reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table 5.2.1.4-1 shows the supported combinations of CSI Reporting configurations and CSI-RS Resource configurations and how the CSI Reporting is triggered for each CSI-RS Resource configuration. Periodic CSI-RS is configured by higher layers. Semi-persistent CSI-RS is activated and deactivated as described in Clause 5.2.1.5.2. Aperiodic CSI-RS is configured and triggered/activated as described in Clause 5.2.1.5.1.

TABLE 5.2.1.4-1
Triggering/Activation of CSI Reporting for the possible CSI-RS Configurations.

| CSI-RS | Periodic CSI | Semi-Persistent CSI | |
|---|---|---|---|
| Configuration | Reporting | Reporting | Aperiodic CSI Reporting |
| Periodic | No dynamic | For reporting on PUCCH, the | Triggered by DCI; |
| CSI-RS | triggering/ | UE receives an activation | additionally, subselection |
| | activation | command, as described in | indication as described in |
| | | clause 6.1.3.16 of [10, TS | clause 6.1.3.13 of [10, TS |
| | | 38.321]; for reporting on | 38.321] possible as |
| | | PUSCH, the UE receives | defined in Clause |
| | | triggering on DCI | 5.2.1.5.1. |
| Semi-Persistent | Not Supported | For reporting on PUCCH, the | Triggered by DCI; |
| CSI-RS | | UE receives an activation | additionally, subselection |
| | | command, as described in | indication as described in |
| | | clause 6.1.3.16 of [10, TS | clause 6.1.3.13 of [10, TS |
| | | 38.321]; for reporting on | 38.321] possible as |
| | | PUSCH, the UE receives | defined in Clause |
| | | triggering on DCI | 5.2.1.5.1. |
| Aperiodic | Not Supported | Not Supported | Triggered by DCI; |
| CSI-RS | | | additionally, subselection |
| | | | indication as described in |
| | | | clause 6.1.3.13 of [10, TS |
| | | | 38.321] possible as |
| | | | defined in Clause |
| | | | 5.2.1.5.1. |

When the UE is configured with higher layer parameter NZP-CSI-RS-ResourceSet and when the higher layer parameter repetition is set to ‘off’, the UE shall determine a CRI from the supported set of CRI values as defined in Clause 6.3.1.1.2 of [5, TS 38.212] and report the number in each CRI report. When the higher layer parameter repetition is set to ‘on’, CRI is not reported. CRI reporting is not supported when the higher layer parameter codebookType is set to ‘typeII’, ‘typeII-PortSelection’, ‘typeII-r16’, to ‘typeII-PortSelection-r16’, or ‘typeII-PortSelection-r17’.

For a semi-persistent CSI report on PUSCH, the periodicity T_{CSI} (measured in slots) is configured by the higher layer parameter reportSlotConfig. Unless specified otherwise, the UE shall transmit the CSI report in frames with SFN n_{f} and slot number within the frame n_{s,f}^{μ} satisfying

$$( {N}_{slot}^{frame , μ} ( {n}_{f} - {n}_{f}^{start} ) + {n}_{s , f}^{μ} - {n}_{s , f}^{start} ) mod {T}_{CSI} = 0$$

where n_{f}^{start} and n_{s,f}^{start} are the SFN and slot number within the frame respectively of the initial semi-persistent PUSCH transmission according to the activating DCI.

For a semi-persistent or aperiodic CSI report on PUSCH, the allowed slot offsets are configured by the following higher layer parameters:
if triggered/activated by DCI format 0_2 and the higher layer parameter reportSlotOffsetListDCI-0-2 is configured, the allowed slot offsets are configured by reportSlotOffsetListDCI-0-2, and
if triggered/activated by DCI format 0_1 and the higher layer parameter reportSlotOffsetListDCI-0-1 is configured, the allowed slot offsets are configured by reportSlotOffsetListDCI-0-1, and
otherwise, the allowed slot offsets are configured by the higher layer parameter reportSlotOffsetList.

The offset is selected in the activating/triggering DCI.

For CSI reporting, a UE can be configured via higher layer signaling with one out of two possible subband sizes, where a subband is defined as N_{PRB}^{SB} contiguous PRBs and depends on the total number of PRBs in the bandwidth part according to Table 5.2.1.4-2.

TABLE 5.2.1.4-2
Configurable subband sizes

| Bandwidth part (PRBs) | Subband size (PRBs) |
|---|---|
| 24-72 | 4, 8 |
| 73-144 | 8, 16 |
| 145-275 | 16, 32 |

The reportFreqConfiguration contained in a CSI-ReportConfig indicates the frequency granularity of the CSI Report. A CSI Reporting Setting configuration defines a CSI reporting band as a subset of subbands of the bandwidth part, where the reportFreqConfiguration indicates:
the csi-ReportingBand as a contiguous or non-contiguous subset of subbands in the bandwidth part for which CSI shall be reported.
   A UE is not expected to be configured with csi-ReportingBand which contains a subband where a CSI-RS resource linked to the CSI Report setting has the frequency density of each CSI-RS port per PRB in the subband less than the configured density of the CSI-RS resource.
   If a CSI-IM resource is linked to the CSI Report Setting, a UE is not expected to be configured with csi-ReportingBand which contains a subband where not all PRBs in the subband have the CSI-IM REs present.
wideband CQI or subband CQI reporting, as configured by the higher layer parameter cqi-FormatIndicator. When wideband CQI reporting is configured, a wideband CQI is reported for each codeword for the entire CSI reporting band. When subband CQI reporting is configured, one CQI for each codeword is reported for each subband in the CSI reporting band.
wideband PMI or subband PMI reporting as configured by the higher layer parameter pmi-FormatIndicator. When wideband PMI reporting is configured, a wideband PMI is reported for the entire CSI reporting band. When subband PMI reporting is configured, except with 2 antenna ports, a single wideband indication (i₁ in Clause 5.2.2.2) is reported for the entire CSI reporting band and one subband indication (i₂ in clause 5.2.2.2) is reported for each subband in the CSI reporting band. When subband PMIs are configured with 2 antenna ports, a PMI is reported for each subband in the CSI reporting band.
   a UE is not expected to be configured with pmi-FormatIndicator if codebookType is set to ‘typeII-r16’ or ‘typeII-PortSelection-r16’ or ‘typeII-PortSelection-r17’.

A CSI Reporting Setting is said to have a wideband frequency-granularity if
reportQuantity is set to ‘cri-RI-PMI-CQI’, or ‘cri-RI-LI-PMI-CQI’, cqi-FormatIndicator is set to ‘widebandCQI’ and pmi-FormatIndicator is set to ‘widebandPMI’, or
reportQuantity is set to ‘cri-RI-PMI-CQI’, or ‘cri-RI-LI-PMI-CQI’, codebookType is set to ‘typeII-PortSelection-r17’ with M=1 and cqi-FormatIndicator is set to ‘widebandCQI’, or
reportQuantity is set to ‘cri-RI-i1’ or
reportQuantity is set to ‘cri-RI-CQI’ or ‘cri-RI-i1-CQI’ and cqi-FormatIndicator is set to ‘widebandCQI’, or
reportQuantity is set to ‘cri-RSRP’ or ‘ssb-Index-RSRP’ or ‘cri-SINR’, or ‘ssb-Index-SINR’
   otherwise, the CSI Reporting Setting is said to have a subband frequency-granularity.

For eType2 and further eType2 port selection CSI, the related feedback overhead is large because of reporting refined CSI. The refined CSI may be transmitted by PUSCH, which includes a first part (i.e. part 1) with a fixed payload size and a second part (i.e. part 2). The detailed information is described as follows, extracted from section 5.2.3 of TS 38.214.

### CSI Reporting Using PUSCH

A UE shall perform aperiodic CSI reporting using PUSCH on serving cell c upon successful decoding of a DCI format 0_1 or DCI format 0_2 which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

An aperiodic CSI report carried on the PUSCH supports wideband, and sub-band frequency granularities. An aperiodic CSI report carried on the PUSCH supports Type I, Type II, Enhanced Type II and Further Enhanced Type II Port Selection CSI.

A UE shall perform semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. Semi-persistent CSI reporting on the PUSCH supports Type I, Type II with wideband, and sub-band frequency granularities, Enhanced Type II and Further Enhanced Type II Port Selection CSI. The PUSCH resources and MCS shall be allocated semi-persistently by an uplink DCI.

CSI reporting on PUSCH can be multiplexed with uplink data on PUSCH except that semi-persistent CSI reporting on PUSCH activated by a DCI format is not expected to be multiplexed with uplink data on the PUSCH. CSI reporting on PUSCH can also be performed without any multiplexing with uplink data from the UE.

Type I CSI feedback is supported for CSI Reporting on PUSCH. Type I wideband and sub-band CSI is supported for CSI Reporting on the PUSCH. Type II CSI is supported for CSI Reporting on the PUSCH.

For Type I, Type II, Enhanced Type II and Further Enhanced Type II Port Selection CSI feedback on PUSCH, a CSI report comprises of two parts. Part 1 has a fixed payload size and is used to identify the number of information bits in Part 2. Part 1 shall be transmitted in its entirety before Part 2.
For Type I CSI feedback, Part 1 contains RI (if reported), CRI (if reported), CQI for the first codeword (if reported). Part 2 contains PMI (if reported), LI (if reported) and contains the CQI for the second codeword (if reported) when RI is larger than 4. For a CSI-ReportConfig configured with codebookType set to ‘typeI-SinglePanel’ and the corresponding CSI-RS Resource Set for channel measurement configured with two Resource Groups and N Resource Pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).
For Type II CSI feedback, Part 1 contains RI (if reported), CQI, and an indication of the number of non-zero wideband amplitude coefficients per layer for the Type II CSI (see Clause 5.2.2.2.3). The fields of Part 1-RI (if reported), CQI, and the indication of the number of non-zero wideband amplitude coefficients for each layer—are separately encoded. Part 2 contains the PMI and LI (if reported) of the Type II CSI. The elements of i_{1,4,l}, i_{2,1,l} (if reported) and i_{2,2,l} (if reported) are reported in the increasing order of their indices, i=0, 1, . . . , L−1, where the element of the lowest index is mapped to the most significant bits and the element of the highest index is mapped to the least significant bits. Part 1 and 2 are separately encoded.
For Enhanced Type II and Further Enhanced Type II Port Selection CSI feedback, Part 1 contains RI (if reported), CQI, and an indication of the overall number of non-zero amplitude coefficients across layers for the Enhanced Type II CSI (see Clause 5.2.2.2.5). The fields of Part 1—RI (if reported), COI, and the indication of the overall number of non-zero amplitude coefficients across layers—are separately encoded. Part 2 contains the PMI of the Enhanced Type II or Further Enhanced Type II Port Selection CSI. Part 1 and 2 are separately encoded.

A Type II CSI report that is carried on the PUSCH shall be computed independently from any Type II CSI report that is carried on the PUCCH formats 3 or 4 (see Clause 5.2.4 and 5.2.2).

When the higher layer parameter reportQuantity is configured with one of the values ‘cri-RSRP’, ‘ssb-Index-RSRP’, ‘cri-SINR’ or ‘ssb-Index-SINR’, the CSI feedback consists of a single part.

For both Type I and Type II reports configured for PUCCH but transmitted on PUSCH, the determination of the payload for CSI part 1 and CSI part 2 follows that of PUCCH as described in Clause 5.2.4.

For Release 15, a CSI reporting mechanism is designed for single TRP transmission. It can also be used to support multiple TRP transmission in Release 16. In Release 17, the CSI reporting mechanism is further optimized for non-coherent joint transmission, where Type1 codebook is assumed. Type2 codebook is not in the scope of Release 17 CSI reporting enhancement since Type2 codebook is refined codebook and is used mainly for multi-user MIMO scenarios.

In the present disclosure, enhanced CSI reporting schemes are proposed for coherent joint transmission, where the same information may be transmitted coherently from multiple TRPs. Here, the CSIs for multiple TRPs are reported for one coherent joint transmission with one joint CSI reporting, or multiple paired or linked CSI reportings. CSI reporting is considered to support both single TRP transmission and coherent joint transmission.

Furthermore, PMI based on enhanced Release 16 or Release 17 Type2 codebook is assumed for CSI reporting, which is maintained in CSI reporting for non-coherent joint transmission. Additional adjustment information, such as phase adjustment and/or amplitude adjustment, may be included in the CSI reporting to further improve system performance.

For legacy reporting schemes, CSI for one TRP is divided into two parts since large feedback overhead is needed for eType2 codebook, where a fixed payload size is used for CSI reporting part 1, including RI (Rank Indicator), CQI (Channel quality indicator), total number of non-zero coefficients summed across all layers K^{NZ} for PMI (Precoding matrix indicator); and a variable payload size is used for CSI reporting part 2 depending on the feedback information (such as RI information) from part 1, which includes PMI information. For the PMI information, it includes 3 groups of feedback bits with different dropping priorities.

With the enhanced CSI reporting schemes for coherent joint transmission, the same information bits may be transmitted from multiple coordinated TRPs to improve cell edge and average throughput. CSI for reporting includes CSI for TRP1, CSI for TRP2 and CSI adjustment between TRP1 and TRP2.

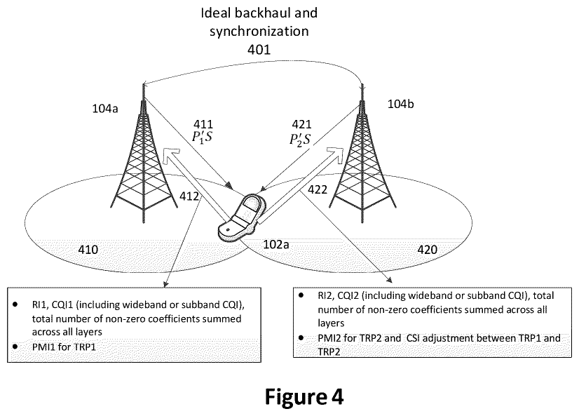

FIG. 4 is a schematic diagram illustrating an example of coherent joint transmission with multiple TRPs in accordance with some implementations of the present disclosure. In this example, the UE 102a is located at the edge of the coverage 410 of the first TRP 104a, and at the edge of the coverage 420 of the second TRP 104b. The UE may be in communication with TRP1 104a and TRP2 104b with communication links 411 and 421, respectively. The CSI feedback may be used for gNB to determine precoding matrix, which includes PMI1 for TRP1, PMI2 for TRP2, and phase adjustment information (which may also be called cophasing information) between TRP1 104a and TRP2 104b. PMI1 for TRP1 and PMI2 for TRP2 may be determined based on CSI between TRP 1 and UE and CSI between TRP2 and UE, respectively, according to existing enhanced Type2 codebook, including e-Type2 codebook in Release 16, e-Type2 port selection codebook in Release 16, and/or fe-Type2 port selection codebook in Release 17. For phase adjustment, it is assumed to be made on PMI2 for TRP2 as it is made relative adjustment based on, or with respect to, PMI1 for TRP1. Upon evaluation of the channel conditions of the communication links/channels, the UE 102a may perform CSI reporting 412 to TRP1 104a and/or CSI reporting 422 to TRP2 104b.

In the example as shown in FIG. 4, the contents of CSI reportings may include RI1, CQI1 (including wideband or subband CQI), total number of non-zero coefficients summed across all layers K₁^{NZ}, which can be reported for TRP1 transmission and/or coherent JT; RI2, CQI2 (including wideband or subband CQI), total number of non-zero coefficients summed across all layers K₂^{NZ} for coherent JT; PMI1 for TRP1, PMI2 for TRP2, and ΔCSI1 for CSI adjustment between TRP1 and TRP2. The CSI adjustment ΔCSI1 may include phase and/or amplitude adjustment information between TRP1 and TRP2.

For reporting of PMI1 and PMI2, the same reporting items (such as legacy i_{1,1}, i_{1,2} for beam selection indication, i_{1,8,1}, . . . , i_{1,8,v} for strongest efficient indication, i_{2,3,1}, . . . , i_{2,3,v} for amplitude coefficient indication for another polarization without strongest efficient, i_{1,5}, i_{1,6,1}, . . . , i_{1,6,v} for indicating selected basic vectors for transformation domain, {i_{2,4,l}}_{l=1, . . . , v)} {i_{2,5,l}}_{l=1, . . . , v} for indicating amplitude and phase for non-zero coefficient in transform domain; {i_{1,7,l}}_{l=1, . . . , v} for indicating non-zero coefficient location by bitmap) may be used, which may be determined based on the enhanced Type2 codebook, including e-Type2 codebook in Release 16, e-Type2 port selection codebook in Release 16, and fe-Type2 port selection codebook in Release 17.

Some examples of the proposed CSI reporting schemes are designed based on one assumption with independent CSI reporting for coherent JT and single TRP transmission, and some are designed on another assumption with joint CSI reporting for coherent JT and single TRP transmission.

Furthermore, one joint CSI reporting, or a plurality of linked or paired CSI reportings, may be used to carry CSI for coherent JT, where CSI from one or more linked or paired reports are used together for one coherent joint transmission. In some examples, three or more TRPs may be used for coherent JT, and thus there may be three or more linked CSI reportings. In some other examples, two TRPs may be used for coherent JT, and thus there may be two paired (or linked) CSI reportings.

### One Joint CSI Reporting for Coherent JT

For this kind of schemes, independent CSI reporting is assumed for coherent JT and single TRP transmission.

The CSI reporting for coherent JT includes two parts. For part 1 (or the first part), it includes common RI1, common CQI1, and common total number of non-zero coefficients summed across all layers K₁^{NZ} for cohere JT. Here, common values are assumed since they are derived based on coherent JT with common values for both TRPs. For part 2 (or the second part), it includes PMI1 for TRP1, PMI2 for TRP2 and additional adjustment information ΔCSI1 for CSI difference between TRP1 and TRP2. The adjustment information, or CSI adjustment, may include phase adjustment and/or amplitude adjustment.

In some examples, the additional CSI adjustment between TRP1 and TRP2 may consist of, or include, phase adjustment information for selected beams, or for subbands, or for linear combination coefficients. Based on this reporting scheme, gNB may make coherent JT based on part 1 CSI reporting information (RI1, CQI1, K₁^{NZ}) and part 2 CSI reporting information (PMI1, PMI2, ΔCSI1).

In some other examples, three TRPs may be used for coherent JT. When three TRPs are used for coherent joint transmission on account of 4 candidate TRPs in Release 18, additional CSI reporting information is needed on top of CSI reporting information for two TRPs. For part 1 in CSI reporting for coherent JT, it is the same as the case with two TRPs. For part 2 in CSI reporting, it further includes PMI3 for TRP3 and additional adjustment information ΔCSI2 for CSI difference between TRP3 and TRP1/2, which may be phase adjustment information between H3 (i.e., channel from TRP3 to UE) and equivalent channel for coherent JT with TRP1 and TRP2. In this way, gNB may further make coherent joint transmission using TRP1, TRP2 and TRP3 based on part 1 (RI1, CQI1, K₁^{NZ}) and part 2 of CSI reporting information (PMI1, PMI2, ΔCSI1, PMI3, ΔCSI2).

### One Joint CSI Reporting for Coherent JT and Single TRP Transmission

For this kind of schemes, joint CSI feedback is assumed for coherent JT and single TRP transmission.

The CSI reporting includes two parts. For part 1, it includes part 1 for single TRP transmission and part 1 for coherent JT. For part 1 for single TRP transmission, it includes RI1, CQI1 and total number of non-zero coefficients summed across all layers K₁^{NZ} for TRP1 assuming single TRP transmission; for part 1 for coherent JT, it includes common RI2, common CQI2 and common total number of non-zero coefficients summed across all layers K₁^{NZ} assuming coherent JT. For part 2, it includes part 2 for single or multiple TRP transmission for TRP1 and part 2 for coherent JT for TRP2. For part 2 for single or multiple TRP transmission for TRP1, it includes PMI1 for TRP1. The PMI1 is determined based on RI2 or max{RI1, RI2}, and is shared by single or multiple TRP transmission. In some other examples, there may be a restriction that RI1=RI2.

If RI value (RI2) for coherent JT is larger than RI value (RI1) for single TRP transmission, the part of PMI1 corresponding to lower layer with index no larger than RI1 is used for single TRP transmission when the PMI1 is determined based on RI2.

If RI value (RI2) for coherent JT is smaller than RI value (RI1) for single TRP transmission, there are two options for solution, namely:
Option1: the part of PMI1 corresponding to lower layer with index no larger than RI2 is used for coherent JT, where PMI is determined based on max{RI1, RI2} or with a restriction that RI1=RI2; and
Option 2: the PMI corresponding to RI2 is used for single TRP transmission, which may cause some performance loss for single TRP transmission.

For part 2 for coherent JT, it includes PMI2 for TRP2 and additional adjustment information ΔCSI1 for CSI difference between TRP1 and TRP2. Based on this reporting scheme, gNB may:
a) make single TRP transmission based on part 1 CSI reporting information for single TRP transmission (RI1, CQI1, K₁^{NZ}) and part 2 CSI reporting information for single or multiple TRP transmission for TRP1 (PMI1); and/or
b) make coherent JT based on part 1 CSI reporting information for coherent JT (RI2, CQI2, K₁^{NZ}), and part 2 CSI reporting information for single or multiple TRP transmission (PMI1) and for coherent JT for TRP2 (PMI2, ΔCSI1).

In most cases, the same rank may be assumed (RI1=RI2) for single TRP transmission and coherent JT transmission when the TRP with better channel quality is chosen for single TRP transmission. With this assumption, CQI2 is typically better than CQI1 since coherent JT can improve system performance. Thus, differential reporting ΔCQI=CQI2−CQI1 with 2 or 3 bits may be used, instead of direct reporting of CQI2, to save feedback overhead.

For example, when two bits are used for differential reporting, for state ‘00’, ΔCQI=0; for state ‘01’, ΔCQI=1; for state ‘10’, ΔCQI=2; for state ‘10’, ΔCQI>=3. When ΔCQI <=0, UE does not report part 2 for coherent JT (PMI2, ΔCSI1) since there is no benefit to make coherent JT for improving throughput.

In some other examples, three TRPs may be used for coherent JT. When three TRPs are used for coherent joint transmission on account of 4 candidate TRPs in Release 18, additional CSI reporting information is needed on top of CSI reporting information for two TRPs. For part 1 in CSI reporting, it includes common RI3, common CQI3 and common total number of non-zero coefficients summed across all layers K₃^{NZ} assuming coherent JT with three TRPs in addition to (RI1, CQI1, K₁^{NZ}) and (RI2, CQI2, K₂^{NZ}) as the case with two TRPs. For part 2 in CSI reporting, it further includes PMI3 for TRP3 and additional adjustment information ΔCSI2 for CSI difference between TRP3 and TRP1/2. In this way, gNB may further make coherent joint transmission using TRP1, TRP2 and TRP3 based on part 1 (RI3, CQI3, K₃^{NZ}) and part 2 of CSI reporting information (PMI1, PMI2, ΔCSI1, PMI3, ΔCSI2).

### Multiple Linked CSI Reportings for Coherent JT

For this kind of schemes, multiple CSI reportings are linked or paired and used together for CSI reporting for coherent JT. gNB may send a configuration signalling for multiple CSI reportings to a UE, where CSI reporting IDs of the other linked CSI reportings may be included as a field, e.g. association field, in the configuration signalling of one CSI reporting.

The CSI for TRP1 is carried by CSI reporting 1; the CSI for TRP2, and CSI adjustment for TRP2 with respect to TRP1, are carried by CSI reporting 2.

In some examples, two TRPs may be used for coherent JT. Independent CSI reporting is assumed for coherent JT and single TRP transmission, and two paired CSI reportings are used for CSI reporting for coherent JT in this embodiment.

For CSI reporting 1, it includes two parts. For part 1 of CSI reporting 1, it includes common RI1, common CQI1 and common total number of non-zero coefficients summed across all layers K₁^{NZ} for coherent JT. Here, common values are assumed since they are derived based on coherent JT with common values for both TRPs. For part 2 of CSI reporting 1, it includes PMI1 for TRP1.

For CSI reporting 2, it includes only part 2 (part 1 is not needed on account of common values for RI, CQI, K^{NZ}). Part 2 of CSI reporting 2 includes PMI2 for TRP2 and additional adjustment information ΔCSI1 for CSI difference between TRP1 and TRP2. The additional CSI adjustment information between TRP1 and TRP2 may consist of, or include, phase and/or amplitude adjustment information for selected beams, or for subband, or for linear combination coefficients. Based on this reporting scheme, gNB may make coherent JT based on part 1 CSI reporting information in CSI reporting 1 (RI1, CQI1, K₁^{NZ}) and part 2 CSI feedback information in CSI reporting 1 (PMI1) and part 2 CSI reporting information in CSI reporting 2 (PMI2, ΔCSI1).

In some other examples, three TRPs may be used for coherent JT. When three TRPs are used for coherent joint transmission on account of 4 candidate TRPs in Release 18, the number of paired CSI reportings may be 3.

For CSI reportings 1 and 2, they are the same as that for the two-TRP case.

For CSI reporting 3, it includes only part 2 since part 1 is not needed on account of common value for RI, CQI, K^{NZ}. For part 2 in CSI reporting 3, it includes PMI3 for TRP3 and additional adjustment information ΔCSI2 for CSI difference between TRP3 and TRP1/2. The additional CSI adjustment information between TRP3 and TRP1/2, may consist of, or include, phase and/or amplitude adjustment information for selected beams, or for subband, or for linear combination coefficients. In addition to support coherent joint transmission between TRP1 and TRP2, gNB may further make coherent joint transmission using TRP1, TRP2 and TRP3 based on part 1 of CSI reporting 1 (RI1, CQI1, K₁^{NZ}) and part 2 of CSI reporting 1, 2 and 3 including (PMI1, PMI2, ΔCSI1, PMI3, ΔCSI2).

### Multiple Linked CSI Reportings for Coherent JT and Single TRP Transmission

For this kind of schemes, multiple CSI reportings are linked or paired, and are used together for CSI reporting for coherent JT. gNB may send a configuration signalling for multiple CSI reportings to a UE, where CSI reporting IDs of the other linked CSI reportings may be included as a field, e.g. association field, in the configuration signalling of one CSI reporting.

Joint CSI feedback is assumed for coherent JT and single TRP transmission. The CSI for TRP1 with single TRP transmission or CJT is carried by CSI reporting 1; the CSI for TRP2 with CJT, and CSI adjustment between TRP1 and TRP2 are carried by CSI reporting 2.

The CSI reporting for coherent JT is designed based on two paired CSI reportings. For CSI reporting 1 and CSI reporting 2, each of the reportings includes two parts.

For part 1 in CSI reporting 1, it includes RI1, CQI1 and common total number of non-zero coefficients summed across all layers K₁^{NZ} for single TRP transmission.

For part 1 in CSI reporting 2, it includes RI2, CQI2 and common total number of non-zero coefficients summed across all layers K₂^{NZ} for coherent JT. Here, common values are assumed since they are derived based on coherent JT with common values for both TRPs.

For part 2 in CSI reporting 1, it includes PMI1 for TRP1. The PMI1 is determined based on RI2 or max{RI1, RI2}, and is shared by single or multiple TRP transmission. In some other examples, there may be a restriction that RI1=RI2.

If RI value (RI2) for coherent JT is larger than RI value (RI1) for single TRP transmission, the part of PMI1 corresponding to lower layer with index no larger than RI1 is used for single TRP transmission when the PMI1 is determined based on RI2.

If RI value (RI2) for coherent JT is smaller than RI value (RI1) for single TRP transmission, there are two options for solution, namely:
Option1: the part of PMI1 corresponding to lower layer with index no larger than RI2 is used for coherent JT, where PMI is determined based on max{RI1, RI2} or with a restriction that RI1=RI2; and
Option 2: the PMI corresponding to RI2 is used for single TRP transmission, which may cause some performance loss for single TRP transmission.

For part 2 in CSI reporting 2, it includes PMI2 for TRP2 and additional adjustment information ΔCSI for CSI difference between TRP1 and TRP2. The additional CSI adjustment information between TRP1 and TRP2 may be phase adjustment information for selected beams, or for subband, or for linear combination coefficients. Based on this reporting scheme, gNB may:
a) make single TRP transmission based on part 1 of CSI reporting 1 (RI1, CQI1, K₁^{NZ}) and part 2 of CSI reporting 1 (PMI1); and/or
b) make coherent JT based on part 1 of CSI reporting 2 (RI2, CQI2, K₂^{NZ}) and part 2 of CSI reporting 1 (PMI1) and part 2 of CSI reporting 2 (PMI2, ΔCSI1).

In most cases, RI1 of CSI reporting 1 may be assumed to be the same as RI2 of CSI reporting 2 when the TRP with better channel quality is chosen for single TRP transmission. With this assumption, CQI2 in CSI reporting 2 is typically better than CQI1 in CSI reporting 1 since coherent JT can improve system performance. Thus, differential reporting ΔCQI=CQI2−CQI1 with 2 or 3 bits can be used instead of direct reporting of CQI2.

For example, when two bits are used for differential reporting, for state ‘00’, ΔCQI<=0; for state ‘01’, ΔCQI=1; for state ‘10’, ΔCQI=2; for state ‘10’, ΔCQI>=3. When ΔCQI<=0, UE does not report part 2 in CSI reporting 2 (PMI2, ΔCSI1) since there is no benefit to make coherent JT for improving throughput.

In some other examples, three TRPs may be used for coherent JT. When three TRPs are used for coherent joint transmission on account of 4 candidate TRPs in Release 18, the number of paired CSI reportings can be 3.

For CSI reporting 1 and 2, they are the same as CSI reportings for two-TRP case.

For CSI reporting 3, it includes two parts. For part 1 in CSI reporting 3, it includes RI3, CQI3 and common total number of non-zero coefficients summed across all layers K₃^{NZ} for coherent JT with three TRPs. For part 2 in CSI reporting 3, it includes PMI3 for TRP3 and additional adjustment information ΔCSI2 for CSI difference between TRP3 and TRP1/2. For additional CSI adjustment information between TRP3 and TRP1/2, it may consist of, or include, phase adjustment information for selected beams, or for subband, or for linear combination coefficients. In addition to support single TRP transmission and coherent joint transmission between TRP1 and TRP2, gNB may further make coherent joint transmission between TRP1, TRP2 and TRP3 based on part 1 of CSI reporting 3 (RI3, CQI3, K₃^{NZ}) and part 2 of CSI reporting 1 (PMI1), part 2 of CSI reporting 2 (PMI2, ΔCSI1) and part 2 of CSI reporting 3 (PMI3, ΔCSI2). When multiple linked or paired CSI reportings are configured for a UE, it may include CSI for multiple transmission assumption. For example, the first CSI reporting (i.e. selected subset 1) may be used for single TRP transmission. The first and second linked CSI reportings (i.e. selected subset 2) may be used for CJT with two TRPs. The first, second and third linked CSI reportings (i.e. selected subset 3) may be used for CJT with three TRPs.

To reduce reporting overhead, UE may select a subset of the linked CSI reportings for reporting which may be determined based on its preferred transmission scheme. Furthermore, UE needs to report an indicator of the selected subset of the linked CSI reportings to align understanding on reporting contents between UE and gNB. Although this example is given for multiple linked or paired CSI reportings, it is still workable with more additional CSI reportings, e.g. CSI reporting for other TRPs assumed single TRP transmission. UE may choose its desirable CSI reporting to make reporting. The indicator of the selected subset of the linked CSI reportings for reporting may be included in the part 1 (i.e. the first part) of CSI reporting. If multiple CSI reportings are selected, the indicator may be included in the part 1 (i.e. the first part) of the CSI reporting with lowest reporting ID or the first CSI reporting among the paired or linked CSI reportings.

Although the description for additional adjustment information ΔCSI between TRPs may be from view of phase adjustment, it may also include amplitude adjustment information between TRPs.

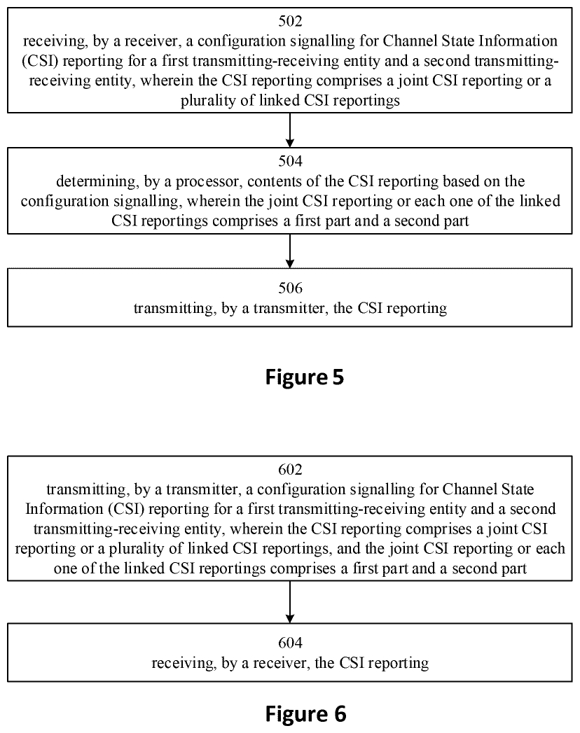

FIG. 5 is a flow chart illustrating steps of CSI reporting for coherent joint transmission by UE 200 in accordance with some implementations of the present disclosure.

At step 502, the receiver 214 of UE 200 receives a configuration signalling for Channel State Information (CSI) reporting for a first transmitting-receiving entity and a second transmitting-receiving entity, wherein the CSI reporting comprises a joint CSI reporting or a plurality of linked CSI reportings.

At step 504, the processor 202 of UE 200 determines contents of the CSI reporting based on the configuration signalling, wherein the joint CSI reporting or each one of the linked CSI reportings comprises a first part and a second part.

At step 506, the transmitter 212 of UE 200 transmits the CSI reporting.

FIG. 6 is a flow chart illustrating steps of CSI reporting for coherent joint transmission by gNB 300 in accordance with some implementations of the present disclosure.

At step 602, the transmitter 312 of gNB 300 transmits a configuration signalling for Channel State Information (CSI) reporting for a first transmitting-receiving entity and a second transmitting-receiving entity, wherein the CSI reporting comprises a joint CSI reporting or a plurality of linked CSI reportings, and the joint CSI reporting or each one of the linked CSI reportings comprises a first part and a second part.

At step 604, the receiver 314 of gNB 300 receives the CSI reporting.

In one aspect, some items as examples of the disclosure concerning UE may be summarized as follows:

1. An apparatus, comprising:
a receiver that receives a configuration signalling for Channel State Information (CSI) reporting for a first transmitting-receiving entity and a second transmitting-receiving entity, wherein the CSI reporting comprises a joint CSI reporting or a plurality of linked CSI reportings;
a processor that determines contents of the CSI reporting based on the configuration signalling, wherein the joint CSI reporting or each one of the linked CSI reportings comprises a first part and a second part; and
a transmitter that transmits the CSI reporting.

2. The apparatus of item 1, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

3. The apparatus of item 1, wherein the second part of the joint CSI reporting comprises a first Precoder Matrix Indicator (PMI1) for the first transmitting-receiving entity, a second PMI (PMI2) for the second transmitting-receiving entity, a first CSI phase adjustment (ΔCSI1) for the PMI2 with coherent joint transmission using the first and second transmitting-receiving entities.

4. The apparatus of item 3, wherein the second part of the joint CSI reporting further comprises a third PMI (PMI3) for a third transmitting-receiving entity, and a second CSI phase adjustment (ΔCSI2) for the PMI3 with coherent joint transmission using the first, second, and third transmitting-receiving entities.

5. The apparatus of item 1, wherein the first part of the joint CSI reporting comprises a first RI (RI1), a first CQI (CQI1), and an indication of total number of non-zero coefficients summed across all layers K₁^{NZ} for transmission with single transmitting-receiving entity; and the first part of the joint CSI reporting further comprises a common RI (RI2), a common CQI (CQI2), and an indication of total number of non-zero coefficients summed across all layers K₂^{NZ} for coherent joint transmission.

6. The apparatus of item 5, wherein the second part of the joint CSI reporting comprises a first PMI (PMI1) for the first transmitting-receiving entity based on the RI2 or max{RI1, RI2} or with a restriction that RI1=RI2, a second PMI (PMI2) for the second transmitting-receiving entity, and a first CSI phase adjustment (ΔCSI1) for the PMI2 with coherent joint transmission using the first and second transmitting-receiving entities.

7. The apparatus of item 6, wherein for transmission with single transmitting-receiving entity, a part of the PMI1 corresponding to lower layers with index no larger than RI1 is used, where RI2>RI1.

8. The apparatus of item 6, wherein contents in the second part of the joint CSI reporting for coherent joint transmission, including PMI2 and ΔCSI1, are not reported, where CQI2<=CQI1.

9. The apparatus of item 5, wherein the first part of the joint CSI reporting further comprises a further common RI (RI3), a further common CQI (CQI3), and an indication of total number of non-zero coefficients summed across all layers K₃^{NZ}; the second part of the joint CSI reporting comprises a further PMI (PMI3) for a third transmitting-receiving entity, and a second CSI phase adjustment (ΔCSI2) for the PMI3 with coherent joint transmission using the first, second, and third transmitting-receiving entities.

10. The apparatus of item 1, wherein the first part of a first linked CSI reporting comprises a common RI, a common CQI and an indication of total number of non-zero coefficients summed across all layers K₁^{NZ}.

11. The apparatus of item 10, wherein the second part of the first linked CSI reporting comprises a first PMI (PMI1) for the first transmitting-receiving entity; the second part of a second linked CSI reporting, which is associated with the first linked CSI reporting, comprises a second PMI (PMI2) for the second transmitting-receiving entity, and a first CSI phase adjustment (ΔCSI1) for the PMI2 with coherent joint transmission using the first and second transmitting-receiving entities.

12. The apparatus of item 11, wherein the second part of a third linked CSI reporting, which is associated with the first and second linked CSI reportings, comprises a third PMI (PMI3) for a third transmitting-receiving entity, and a second CSI phase adjustment (ΔCSI2) for the PMI3 with coherent joint transmission using the first, second, and third transmitting-receiving entities.

13. The apparatus of item 1, wherein the first part of a first linked CSI reporting comprises a first RI (RI1), a first CQI (CQI1), and an indication of total number of non-zero coefficients summed across all layers K₁^{NZ} for the first transmitting-receiving entity for transmission with single transmitting-receiving entity; the first part of a second linked CSI reporting, which is associated with the first linked CSI reporting, comprises a common RI (RI2), a common CQI (CQI2) and an indication of total number of non-zero coefficients summed across all layers K₂^{NZ} for coherent joint transmission.

14. The apparatus of item 13, wherein the second part of the first linked CSI reporting comprises a first PMI (PMI1) for the first transmitting-receiving entity based on the RI2 or max{RI1, RI2} or with a restriction that RI1=RI2; the second part of the second linked CSI reporting comprises a second PMI (PMI2) for the second transmitting-receiving entity, and a first CSI phase adjustment (ΔCSI1) for the PMI2 with coherent joint transmission using the first and second transmitting-receiving entities.

15. The apparatus of item 14, wherein for transmission with single transmitting-receiving entity, a part of the PMI1 corresponding to lower layers with index no larger than RI1 is used, where RI2>RI1.

16. The apparatus of item 14, wherein contents in the second part of the joint CSI reporting for coherent joint transmission, including PMI2 and ΔCSI1, are not reported, where CQI2<=CQI1.

17. The apparatus of item 13, wherein the first part of a third linked CSI reporting, which is associated with the first and second linked CSI reportings, comprises a common RI (RI3), a common CQI (CQI3), and an indication of total number of non-zero coefficients summed across all layers K₃^{NZ}; and the second part of the third linked CSI reporting comprises a third PMI (PMI3) for a third transmitting-receiving entity, and a second CSI phase adjustment (ΔCSI2) for the PMI3 with coherent joint transmission using the first, second, and third transmitting-receiving entities.

18. The apparatus of any one of items 13 to 17, wherein the processor further determines a selected subset of the linked CSI reportings for transmission, comprising:
the first linked CSI reporting;
the first and second linked CSI reportings; or
the first, second and third linked CSI reportings.

19. The apparatus of item 18, wherein the first part of the first linked CSI reporting further comprises an indicator of the selected subset of the linked CSI reportings.

In another aspect, some items as examples of the disclosure concerning gNB may be summarized as follows:

20. An apparatus, comprising:
a transmitter that transmits a configuration signalling for Channel State Information (CSI) reporting for a first transmitting-receiving entity and a second transmitting-receiving entity, wherein the CSI reporting comprises a joint CSI reporting or a plurality of linked CSI reportings, and the joint CSI reporting or each one of the linked CSI reportings comprises a first part and a second part; and a receiver that receives the CSI reporting.

21. The apparatus of item 20, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

22. The apparatus of item 20, wherein the second part of the joint CSI reporting comprises a first Precoder Matrix Indicator (PMI1) for the first transmitting-receiving entity, a second PMI (PMI2) for the second transmitting-receiving entity, a first CSI phase adjustment (ΔCSI1) for the PMI2 with coherent joint transmission using the first and second transmitting-receiving entities.

23. The apparatus of item 22, wherein the second part of the joint CSI reporting further comprises a third PMI (PMI3) for a third transmitting-receiving entity, and a second CSI phase adjustment (ΔCSI2) for the PMI3 with coherent joint transmission using the first, second, and third transmitting-receiving entities.

24. The apparatus of item 20, wherein the first part of the joint CSI reporting comprises a first RI (RI1), a first CQI (CQI1), and an indication of total number of non-zero coefficients summed across all layers K₁^{NZ} for transmission with single transmitting-receiving entity; and the first part of the joint CSI reporting further comprises a common RI (RI2), a common CQI (CQI2), and an indication of total number of non-zero coefficients summed across all layers K₂^{NZ} for coherent joint transmission.

25. The apparatus of item 24, wherein the second part of the joint CSI reporting comprises a first PMI (PMI1) for the first transmitting-receiving entity based on the RI2 or max{RI1, RI2} or with a restriction that RI1=RI2, a second PMI (PMI2) for the second transmitting-receiving entity, and a first CSI phase adjustment (ΔCSI1) for the PMI2 with coherent joint transmission using the first and second transmitting-receiving entities.

26. The apparatus of item 25, wherein for transmission with single transmitting-receiving entity, a part of the PMI1 corresponding to lower layers with index no larger than RI1 is used, where RI2>RI1.

27. The apparatus of item 25, wherein contents in the second part of the joint CSI reporting for coherent joint transmission, including PMI2 and ΔCSI1, are not reported, where CQI2<=CQI1.

28. The apparatus of item 24, wherein the first part of the joint CSI reporting further comprises a further common RI (RI3), a further common CQI (CQI3), and an indication of total number of non-zero coefficients summed across all layers K₃^{NZ}; the second part of the joint CSI reporting comprises a further PMI (PMI3) for a third transmitting-receiving entity, and a second CSI phase adjustment (ΔCSI2) for the PMI3 with coherent joint transmission using the first, second, and third transmitting-receiving entities.

29. The apparatus of item 20, wherein the first part of a first linked CSI reporting comprises a common RI, a common CQI and an indication of total number of non-zero coefficients summed across all layers K₁^{NZ}.

30. The apparatus of item 29, wherein the second part of the first linked CSI reporting comprises a first PMI (PMI1) for the first transmitting-receiving entity; the second part of a second linked CSI reporting, which is associated with the first linked CSI reporting, comprises a second PMI (PMI2) for the second transmitting-receiving entity, and a first CSI phase adjustment (ΔCSI1) for the PMI2 with coherent joint transmission using the first and second transmitting-receiving entities.

31. The apparatus of item 30, wherein the second part of a third linked CSI reporting, which is associated with the first and second linked CSI reportings, comprises a third PMI (PMI3) for a third transmitting-receiving entity, and a second CSI phase adjustment (ΔCSI2) for the PMI3 with coherent joint transmission using the first, second, and third transmitting-receiving entities.

32. The apparatus of item 20, wherein the first part of a first linked CSI reporting comprises a first RI (RI1), a first CQI (CQI1), and an indication of total number of non-zero coefficients summed across all layers K₁^{NZ} for the first transmitting-receiving entity for transmission with single transmitting-receiving entity; the first part of a second linked CSI reporting, which is associated with the first linked CSI reporting, comprises a common RI (RI2), a common CQI (CQI2) and an indication of total number of non-zero coefficients summed across all layers K₂^{NZ} for coherent joint transmission.

33. The apparatus of item 32, wherein the second part of the first linked CSI reporting comprises a first PMI (PMI1) for the first transmitting-receiving entity based on the RI2 or max{RI1, RI2} or with a restriction that RI1=RI2; the second part of the second linked CSI reporting comprises a second PMI (PMI2) for the second transmitting-receiving entity, and a first CSI phase adjustment (ΔCSI1) for the PMI2 with coherent joint transmission using the first and second transmitting-receiving entities.

34. The apparatus of item 33, wherein for transmission with single transmitting-receiving entity, a part of the PMI1 corresponding to lower layers with index no larger than RI1 is used, where RI2>RI1.

35. The apparatus of item 33, wherein contents in the second part of the joint CSI reporting for coherent joint transmission, including PMI2 and ΔCSI1, are not reported, where CQI2<=CQI1.

36. The apparatus of item 32, wherein the first part of a third linked CSI reporting, which is associated with the first and second linked CSI reportings, comprises a common RI (RI3), a common CQI (CQI3), and an indication of total number of non-zero coefficients summed across all layers K₃^{NZ}; and the second part of the third linked CSI reporting comprises a third PMI (PMI3) for a third transmitting-receiving entity, and a second CSI phase adjustment (ΔCSI2) for the PMI3 with coherent joint transmission using the first, second, and third transmitting-receiving entities.

37. The apparatus of any one of items 32 to 36, wherein the CSI reporting received comprises a selected subset of the linked CSI reportings, comprising:
the first linked CSI reporting;
the first and second linked CSI reportings; or
the first, second and third linked CSI reportings.

38. The apparatus of item 37, wherein the first part of the first linked CSI reporting further comprises an indicator of the selected subset of the linked CSI reportings.

In a further aspect, some items as examples of the disclosure concerning a method of UE may be summarized as follows:

39. A method, comprising:
receiving, by a receiver, a configuration signalling for Channel State Information (CSI) reporting for a first transmitting-receiving entity and a second transmitting-receiving entity, wherein the CSI reporting comprises a joint CSI reporting or a plurality of linked CSI reportings;
determining, by a processor, contents of the CSI reporting based on the configuration signalling, wherein the joint CSI reporting or each one of the linked CSI reportings comprises a first part and a second part; and
transmitting, by a transmitter, the CSI reporting.

40. The method of item 39, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

41. The method of item 39, wherein the second part of the joint CSI reporting comprises a first Precoder Matrix Indicator (PMI1) for the first transmitting-receiving entity, a second PMI (PMI2) for the second transmitting-receiving entity, a first CSI phase adjustment (ΔCSI1) for the PMI2 with coherent joint transmission using the first and second transmitting-receiving entities.

42. The method of item 41, wherein the second part of the joint CSI reporting further comprises a third PMI (PMI3) for a third transmitting-receiving entity, and a second CSI phase adjustment (ΔCSI2) for the PMI3 with coherent joint transmission using the first, second, and third transmitting-receiving entities.

43. The method of item 39, wherein the first part of the joint CSI reporting comprises a first RI (RI1), a first CQI (CQI1), and an indication of total number of non-zero coefficients summed across all layers K₁^{NZ} for transmission with single transmitting-receiving entity; and the first part of the joint CSI reporting further comprises a common RI (RI2), a common CQI (CQI2), and an indication of total number of non-zero coefficients summed across all layers K₂^{NZ} for coherent joint transmission.

44. The method of item 43, wherein the second part of the joint CSI reporting comprises a first PMI (PMI1) for the first transmitting-receiving entity based on the RI2 or max{RI1, RI2} or with a restriction that RI1=RI2, a second PMI (PMI2) for the second transmitting-receiving entity, and a first CSI phase adjustment (ΔCSI1) for the PMI2 with coherent joint transmission using the first and second transmitting-receiving entities.

45. The method of item 44, wherein for transmission with single transmitting-receiving entity, a part of the PMI1 corresponding to lower layers with index no larger than RI1 is used, where RI2>RI1.

46. The method of item 44, wherein contents in the second part of the joint CSI reporting for coherent joint transmission, including PMI2 and ΔCSI1, are not reported, where CQI2<=CQI1.

47. The method of item 43, wherein the first part of the joint CSI reporting further comprises a further common RI (RI3), a further common CQI (CQI3), and an indication of total number of non-zero coefficients summed across all layers K₃^{NZ}; the second part of the joint CSI reporting comprises a further PMI (PMI3) for a third transmitting-receiving entity, and a second CSI phase adjustment (ΔCSI2) for the PMI3 with coherent joint transmission using the first, second, and third transmitting-receiving entities.

48. The method of item 39, wherein the first part of a first linked CSI reporting comprises a common RI, a common CQI and an indication of total number of non-zero coefficients summed across all layers K₁^{NZ}.

49. The method of item 48, wherein the second part of the first linked CSI reporting comprises a first PMI (PMI1) for the first transmitting-receiving entity; the second part of a second linked CSI reporting, which is associated with the first linked CSI reporting, comprises a second PMI (PMI2) for the second transmitting-receiving entity, and a first CSI phase adjustment (ΔCSI1) for the PMI2 with coherent joint transmission using the first and second transmitting-receiving entities.

50. The method of item 49, wherein the second part of a third linked CSI reporting, which is associated with the first and second linked CSI reportings, comprises a third PMI (PMI3) for a third transmitting-receiving entity, and a second CSI phase adjustment (ΔCSI2) for the PMI3 with coherent joint transmission using the first, second, and third transmitting-receiving entities.

51. The method of item 39, wherein the first part of a first linked CSI reporting comprises a first RI (RI1), a first CQI (CQI1), and an indication of total number of non-zero coefficients summed across all layers K₁^{NZ} for the first transmitting-receiving entity for transmission with single transmitting-receiving entity; the first part of a second linked CSI reporting, which is associated with the first linked CSI reporting, comprises a common RI (RI2), a common CQI (CQI2) and an indication of total number of non-zero coefficients summed across all layers K₂^{NZ} for coherent joint transmission.

52. The method of item 51, wherein the second part of the first linked CSI reporting comprises a first PMI (PMI1) for the first transmitting-receiving entity based on the RI2 or max{RI1, RI2} or with a restriction that RI1=RI2; the second part of the second linked CSI reporting comprises a second PMI (PMI2) for the second transmitting-receiving entity, and a first CSI phase adjustment (ΔCSI1) for the PMI2 with coherent joint transmission using the first and second transmitting-receiving entities.

53. The method of item 52, wherein for transmission with single transmitting-receiving entity, a part of the PMI1 corresponding to lower layers with index no larger than RI1 is used, where RI2>RI1.

54. The method of item 52, wherein contents in the second part of the joint CSI reporting for coherent joint transmission, including PMI2 and ΔCSI1, are not reported, where CQI2<=CQI1.

55. The method of item 51, wherein the first part of a third linked CSI reporting, which is associated with the first and second linked CSI reportings, comprises a common RI (RI3), a common CQI (CQI3), and an indication of total number of non-zero coefficients summed across all layers K₃^{NZ}; and the second part of the third linked CSI reporting comprises a third PMI (PMI3) for a third transmitting-receiving entity, and a second CSI phase adjustment (ΔCSI2) for the PMI3 with coherent joint transmission using the first, second, and third transmitting-receiving entities.

56. The method of any one of items 51 to 55, wherein the processor further determines a selected subset of the linked CSI reportings for transmission, comprising:
the first linked CSI reporting;
the first and second linked CSI reportings; or
the first, second and third linked CSI reportings.

57. The method of item 56, wherein the first part of the first linked CSI reporting further comprises an indicator of the selected subset of the linked CSI reportings.

In a yet further aspect, some items as examples of the disclosure concerning a method of gNB may be summarized as follows:

58. A method, comprising:
transmitting, by a transmitter, a configuration signalling for Channel State Information (CSI) reporting for a first transmitting-receiving entity and a second transmitting-receiving entity, wherein the CSI reporting comprises a joint CSI reporting or a plurality of linked CSI reportings, and the joint CSI reporting or each one of the linked CSI reportings comprises a first part and a second part; and
receiving, by a receiver, the CSI reporting.

59. The method of item 58, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

60. The method of item 58, wherein the second part of the joint CSI reporting comprises a first Precoder Matrix Indicator (PMI1) for the first transmitting-receiving entity, a second PMI (PMI2) for the second transmitting-receiving entity, a first CSI phase adjustment (ΔCSI1) for the PMI2 with coherent joint transmission using the first and second transmitting-receiving entities.

61. The method of item 60, wherein the second part of the joint CSI reporting further comprises a third PMI (PMI3) for a third transmitting-receiving entity, and a second CSI phase adjustment (ΔCSI2) for the PMI3 with coherent joint transmission using the first, second, and third transmitting-receiving entities.

62. The method of item 58, wherein the first part of the joint CSI reporting comprises a first RI (RI1), a first CQI (CQI1), and an indication of total number of non-zero coefficients summed across all layers K₁^{NZ} for transmission with single transmitting-receiving entity; and the first part of the joint CSI reporting further comprises a common RI (RI2), a common CQI (CQI2), and an indication of total number of non-zero coefficients summed across all layers K₂^{NZ} for coherent joint transmission.

63. The method of item 62, wherein the second part of the joint CSI reporting comprises a first PMI (PMI1) for the first transmitting-receiving entity based on the RI2 or max{RI1, RI2} or with a restriction that RI1=RI2, a second PMI (PMI2) for the second transmitting-receiving entity, and a first CSI phase adjustment (ΔCSI1) for the PMI2 with coherent joint transmission using the first and second transmitting-receiving entities.

64. The method of item 63, wherein for transmission with single transmitting-receiving entity, a part of the PMI1 corresponding to lower layers with index no larger than RI1 is used, where RI2>RI1.

65. The method of item 63, wherein contents in the second part of the joint CSI reporting for coherent joint transmission, including PMI2 and ΔCSI1, are not reported, where CQI2<=CQI1.

66. The method of item 62, wherein the first part of the joint CSI reporting further comprises a further common RI (RI3), a further common CQI (CQI3), and an indication of total number of non-zero coefficients summed across all layers K₃^{NZ}; the second part of the joint CSI reporting comprises a further PMI (PMI3) for a third transmitting-receiving entity, and a second CSI phase adjustment (ΔCSI2) for the PMI3 with coherent joint transmission using the first, second, and third transmitting-receiving entities.

67. The method of item 58, wherein the first part of a first linked CSI reporting comprises a common RI, a common CQI and an indication of total number of non-zero coefficients summed across all layers K₁^{NZ}.

68. The method of item 67, wherein the second part of the first linked CSI reporting comprises a first PMI (PMI1) for the first transmitting-receiving entity; the second part of a second linked CSI reporting, which is associated with the first linked CSI reporting, comprises a second PMI (PMI2) for the second transmitting-receiving entity, and a first CSI phase adjustment (ΔCSI1) for the PMI2 with coherent joint transmission using the first and second transmitting-receiving entities.

69. The method of item 68, wherein the second part of a third linked CSI reporting, which is associated with the first and second linked CSI reportings, comprises a third PMI (PMI3) for a third transmitting-receiving entity, and a second CSI phase adjustment (ΔCSI2) for the PMI3 with coherent joint transmission using the first, second, and third transmitting-receiving entities.

70. The method of item 58, wherein the first part of a first linked CSI reporting comprises a first RI (RI1), a first CQI (CQI1), and an indication of total number of non-zero coefficients summed across all layers K₁^{NZ} for the first transmitting-receiving entity for transmission with single transmitting-receiving entity; the first part of a second linked CSI reporting, which is associated with the first linked CSI reporting, comprises a common RI (RI2), a common CQI (CQI2) and an indication of total number of non-zero coefficients summed across all layers K₂^{NZ} for coherent joint transmission.

71. The method of item 70, wherein the second part of the first linked CSI reporting comprises a first PMI (PMI1) for the first transmitting-receiving entity based on the RI2 or max{RI1, RI2} or with a restriction that RI1=RI2; the second part of the second linked CSI reporting comprises a second PMI (PMI2) for the second transmitting-receiving entity, and a first CSI phase adjustment (ΔCSI1) for the PMI2 with coherent joint transmission using the first and second transmitting-receiving entities.

72. The method of item 71, wherein for transmission with single transmitting-receiving entity, a part of the PMI1 corresponding to lower layers with index no larger than RI1 is used, where RI2>RI1.

73. The method of item 71, wherein contents in the second part of the joint CSI reporting for coherent joint transmission, including PMI2 and ΔCSI1, are not reported, where CQI2<=CQI1.

74. The method of item 70, wherein the first part of a third linked CSI reporting, which is associated with the first and second linked CSI reportings, comprises a common RI (RI3), a common CQI (CQI3), and an indication of total number of non-zero coefficients summed across all layers K₃^{NZ}; and the second part of the third linked CSI reporting comprises a third PMI (PMI3) for a third transmitting-receiving entity, and a second CSI phase adjustment (ΔCSI2) for the PMI3 with coherent joint transmission using the first, second, and third transmitting-receiving entities.

75. The method of any one of items 70 to 74, wherein the CSI reporting received comprises a selected subset of the linked CSI reportings, comprising:
the first linked CSI reporting;
the first and second linked CSI reportings; or
the first, second and third linked CSI reportings.

76. The method of item 75, wherein the first part of the first linked CSI reporting further comprises an indicator of the selected subset of the linked CSI reportings.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
receive a configuration signaling for Channel State Information (CSI) reporting for a first transmitting-receiving entity and a second transmitting-receiving entity, wherein the CSI reporting comprises a joint CSI reporting;
determine contents of the CSI reporting based on the configuration signaling, wherein the joint CSI reporting comprises a first part and a second part; and
transmit the CSI reporting.

2. The apparatus of claim 1, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

3. The apparatus of claim 1, wherein the second part of the joint CSI reporting comprises a first Precoder Matrix Indicator (PMI1) for the first transmitting-receiving entity, a second PMI (PMI2) for the second transmitting-receiving entity, and a first CSI phase adjustment (ΔCSI1) for the PMI2 with coherent joint transmission using the first and second transmitting-receiving entities.

4. The apparatus of claim 1, wherein the first part of the joint CSI reporting comprises a first RI (RI1), a first CQI (CQI1), and an indication of total number of non-zero coefficients summed across all layers K₁^{NZ} for transmission with a single transmitting-receiving entity; and wherein the first part of the joint CSI reporting further comprises a common RI (RI2), a common CQI (CQI2), and an indication of a total number of non-zero coefficients summed across all layers K₂^{NZ} for coherent joint transmission.

5. The apparatus of claim 4, wherein the second part of the joint CSI reporting comprises a first PMI (PMI1) for the first transmitting-receiving entity based on the RI2 or max{RI1, RI2} or with a restriction that RI1=RI2, a second PMI (PMI2) for the second transmitting-receiving entity, and a first CSI phase adjustment (ΔCSI1) for the PMI2 with coherent joint transmission using the first and second transmitting-receiving entities.

6. The apparatus of claim 5, wherein, for transmission with the single transmitting-receiving entity, a part of the PMI1 corresponding to lower layers with an index no larger than RI1 is used, where RI2>RI1.

7. The apparatus of claim 1, wherein a first part of a first linked CSI reporting comprises a common RI, a common CQI, and an indication of a total number of non-zero coefficients summed across all layers K₁^{NZ}.

8. The apparatus of claim 7, wherein: a second part of the first linked CSI reporting comprises a first PMI (PMI1) for the first transmitting-receiving entity; a second part of a second linked CSI reporting, which is associated with the first linked CSI reporting, comprises a second PMI (PMI2) for the second transmitting-receiving entity; and a first CSI phase adjustment (ΔCSI1) for the PMI2 with coherent joint transmission using the first and second transmitting-receiving entities.

9. The apparatus of claim 1, wherein: a first part of a first linked CSI reporting comprises a first RI (RI1), a first CQI (CQI1), and an indication of a total number of non-zero coefficients summed across all layers K₁^{NZ} for the first transmitting-receiving entity for transmission with a single transmitting-receiving entity; and a first part of a second linked CSI reporting, which is associated with the first linked CSI reporting, comprises a common RI (RI2), a common CQI (CQI2) and an indication of a total number of non-zero coefficients summed across all layers K₂^{NZ} for coherent joint transmission.

10. The apparatus of claim 9, wherein: a second part of the first linked CSI reporting comprises a first PMI (PMI1) for the first transmitting-receiving entity based on the RI2 or max{RI1, RI2} or with a restriction that RI1=RI2; a second part of the second linked CSI reporting comprises a second PMI (PMI2) for the second transmitting-receiving entity, and a first CSI phase adjustment (ΔCSI1) for the PMI2 with coherent joint transmission using the first and second transmitting-receiving entities.

11. The apparatus of claim 10, wherein, for transmission with the single transmitting-receiving entity, a part of the PMI1 corresponding to lower layers with an index no larger than RI1 is used, where RI2>RI1.

12. The apparatus of claim 9, wherein a first part of a third linked CSI reporting, which is associated with the first and second linked CSI reportings, comprises a common RI (RI3), a common CQI (CQI3), and an indication of a total number of non-zero coefficients summed across all layers K₃^{NZ}; and a second part of the third linked CSI reporting comprises a third PMI (PMI3) for a third transmitting-receiving entity, and a second CSI phase adjustment (ΔCSI2) for the PMI3 with coherent joint transmission using the first, second, and third transmitting-receiving entities.

13. The apparatus of claim 12, wherein the at least one processor is further configured to cause the apparatus to determine a selected subset of the linked CSI reportings for transmission, wherein the selected subset includes:
the first linked CSI reporting;
the first and second linked CSI reportings; or
the first, second, and third linked CSI reportings;
wherein the first part of the first linked CSI reporting further comprises an indicator of the selected subset of the linked CSI reportings.

14. An apparatus for wireless communication, comprising:
at least one memory; and
at least one processor coupled with the at least one memory and configured to cause the apparatus to:
transmit a configuration signaling for Channel State Information (CSI) reporting for a first transmitting-receiving entity and a second transmitting-receiving entity,
wherein the CSI reporting comprises a joint CSI reporting having a first part and a second part; and
receive the CSI reporting.

15. A method, comprising:
receiving a configuration signaling for Channel State Information (CSI) reporting for a first transmitting-receiving entity and a second transmitting-receiving entity, wherein the CSI reporting comprises a joint CSI reporting;
determining contents of the CSI reporting based on the configuration signaling, wherein the joint CSI reporting comprises a first part and a second part; and
transmitting the CSI reporting.

16. The method of claim 15, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

17. The method of claim 15, wherein the second part of the joint CSI reporting comprises a first Precoder Matrix Indicator (PMI1) for the first transmitting-receiving entity, a second PMI (PMI2) for the second transmitting-receiving entity, and a first CSI phase adjustment (ΔCSI1) for the PMI2 with coherent joint transmission using the first and second transmitting-receiving entities.

18. A processor for wireless communication, comprising:
at least one controller coupled with at least one memory and configured to cause the processor to:
receive a configuration signaling for Channel State Information (CSI) reporting for a first transmitting-receiving entity and a second transmitting-receiving entity, wherein the CSI reporting comprises a joint CSI reporting;
determine contents of the CSI reporting based on the configuration signaling, wherein the joint CSI reporting comprises a first part and a second part; and
transmit the CSI reporting.

19. The processor of claim 18, wherein the first part of the joint CSI reporting comprises a common Rank Indicator (RI1), a common Channel Quality Indicator (CQI1), and an indication of total number of non-zero coefficients summed across all layers K₁^{NZ} for coherent joint transmission.

20. The processor of claim 18, wherein the second part of the joint CSI reporting comprises a first Precoder Matrix Indicator (PMI1) for the first transmitting-receiving entity, a second PMI (PMI2) for the second transmitting-receiving entity, and a first CSI phase adjustment (ΔCSI1) for the PMI2 with coherent joint transmission using the first and second transmitting-receiving entities.
